(19) United States
(12) Patent Application Publication
(10) Pub. No.: US 2010/0228665 A1
(43) Pub. Date: Sep. 9, 2010

(54) Collateral Management System and Method

(76) Inventors: Kelly Mathieson, New York, NY (US); John Rivett, Poole (GB); Emma Mangan, London (GB)

Correspondence Address: GOODWIN PROCTER LLP, 901 NEW YORK AVENUE, N.W., WASHINGTON, DC, 20001, US

(21) Appl. No.: 12/715,532

(22) Filed: Mar. 2, 2010

Related U.S. Application Data
(60) Provisional application No. 61/157,962, filed on Mar. 6, 2009.

(51) Int. Cl. G06Q 40/00

(52) U.S. Cl. 705/38

(57) ABSTRACT

Embodiments of the invention include a computer-implemented collateral management system and method for managing collateral of multiple participants including borrowers and lenders. The system may include a global long box available to each borrower, each global long box configured for storing all types of available assets possessed by each borrower. The system may additionally include an eligibility database storing eligibility and concentration limits, the concentration limits defined by lender rules controlling the acceptability of the available assets for use as collateral, the value of the assets, and overall acceptable composition of assets. An interactive participant interface may be provided for accepting collateral use preferences from the borrowers, the collateral use preferences including, lender ranking components, asset ranking components, and allocation run type selection components for facilitating collateral allocation. An allocation engine implementing computer processing components for selecting an allocation sequence based on the collateral use preferences of the borrowers and in compliance the stored eligibility and concentration limits in the eligibility database and allocating collateral from each global long box in the selected sequence.

### RELATED APPLICATIONS

This application claims priority to provisional application Ser. No. 61/157,962 filed on Mar. 6, 2009. This application also incorporates by reference commonly owned PCT Application Serial No. PCT US09/52420, filed on Jul. 31, 2009, which claims priority to U.S. Provisional Application Ser. No. 61/085,563, filed on Aug. 1, 2008.

### TECHNICAL FIELD

Embodiments of the invention are related generally to systems and methods for facilitating collateral management in the financial industry.

### BACKGROUND OF THE INVENTION

Currently, available collateral management systems are limited in multiple respects. Collateral refers to a security or a physical asset that can be pledged to secure repayment of what one party owes another party. Most collateral management systems include discrete platforms for operating on different types of collateral assets, such as securities or cash or for different obligation types, such as repurchase agreements (repo) or derivatives. Therefore, to manage different types of collateral and obligations, a participant may be required to access multiple platforms through discrete user interfaces, systems, reporting, etc. Excessive manual intervention is typically required in eligibility, allocation, and reconciliation processes.

Furthermore, existing collateral management systems typically only account for fresh collateral and single instances of rehypothecation or collateral re-use. Rehypothecation is the ability to re-use assets that one has received as collateral against an obligation of one's own. Existing systems do not have the capability for multiple rehypothecations of collateral.

One known system for collateral management is disclosed in U.S. Pat. No. 7,480,632 to Fudali et al., which is hereby incorporated by reference. Fudali discloses a process for allocating specific assets from a pool of assets to secure a liability. Information concerning each of the assets in the pool of assets is received from at least two sources. A set of validation rules is applied to the information for each asset in the pool of assets and those assets not meeting the validation rules are rejected. A price is assigned to each non-rejected asset. A subset of the non-rejected assets is allocated to the liability as a function to collateralize the liability.

The system of Fudali is a basic system that does not handle rehypothecation. The system of Fudali further does not include multiple selectable pre-defined types of allocation runs. Other drawbacks and deficiencies are inherent in Fudali and other existing collateral allocation systems.

Thus, a solution is needed that provides a fully automated, collateral eligibility and allocation management system that allows for re-use and for multiple asset types. The system should be operable regardless of the type of underlying obligation.

### SUMMARY OF THE INVENTION

In one aspect of the invention, a computer implemented collateral management system is provided for managing collateral of multiple participants including borrowers and lenders. The system comprises a global long box available to each borrower, each global long box configured for storing all types of available assets possessed by each borrower. The system additionally includes an eligibility database storing eligibility and concentration limits, the concentration limits defined by lender rules controlling the acceptability of the available assets for use as collateral, the value of the assets, and overall acceptable composition of assets. The system additionally includes an interactive participant interface accepting collateral use preferences from the borrowers, the collateral use preferences including, lender ranking components, asset ranking components, and allocation run type selection components for facilitating collateral allocation. The system additionally includes an allocation engine implementing computer processing components for selecting an allocation sequence based on the collateral use preferences of the borrowers and in compliance the stored eligibility and concentration limits in the eligibility database and allocating collateral from each global long box in the selected sequence.

In an additional aspect of the invention, a computer-implemented method is provided for managing collateral of multiple participants including borrowers and lenders. The method comprises maintaining a global long box available to each borrower, wherein each global long box configured for storing all available types of assets possessed by each borrower. The method additionally includes storing eligibility and concentration limits in an eligibility database, the concentration limits defined by lender rules controlling the acceptability of the available assets for use as collateral, the value of the assets, and overall acceptable composition of assets. The method further includes accepting collateral use preferences through an interactive participant interface from borrowers, the collateral use preferences including, lender ranking components, asset ranking components, and allocation run type selection components for facilitating collateral allocation. The method further includes selecting, using an allocation engine implementing computer processing components, an allocation sequence based on the collateral use preferences of the borrowers and in compliance the stored eligibility and concentration limits in the eligibility database, and allocating collateral using the allocation engine implementing computer processing components in accordance with the selected sequence.

In yet an additional aspect of the invention, a computer-implemented method is provided for managing collateral of multiple participants including borrowers and lenders, the method comprising maintaining a global long box available to each borrower, each global long box configured for storing all available types of assets possessed by each borrower, and storing eligibility and concentration limits in an eligibility database. The concentration limits are defined by lender rules controlling the acceptability of the available assets for use as collateral, the value of the assets, and overall acceptable composition of assets and the eligibility and concentration limits include parameters established for the requirement of acceptable collateral by lenders including eligible types of collateral and an amount of collateral. The method additionally includes accepting collateral use preferences through an interactive participant interface from the borrowers, the collateral use preferences including, lender ranking components, asset ranking components, and allocation run type selection components for facilitating collateral allocation. The method further includes selecting, using an allocation engine implementing computer processing components, a collateral allocation sequence selected based on the collateral use preferences of the borrowers and in compliance the stored eligibility and concentration limits in the eligibility database. The selected allocation sequence includes at least one of: an optimization allocation sequence including either allocating to achieve best coverage of assets or allocating to achieve best value for assets; a top up allocation sequence including the steps of keeping existing positions locked and allocating only unallocated assets from the borrower global long box; and a minimum movements allocation sequence including the step of calculating an optimal allocation based on a minimum amount of asset movement. The method further includes allocating collateral using an allocation engine implementing computer processing components for allocating collateral from each global long box in the selected sequence.

### BRIEF DESCRIPTION OF THE DRAWINGS

The present invention is described in detail below with reference to the attached drawings figures, wherein:

FIG. 1 is a block diagram illustrating an operating environment for global collateral management system in accordance with an embodiment of the invention;

FIG. 2 is a block diagram illustrating a global collateral management system in accordance with an embodiment of the invention;

FIG. 3 is a block diagram illustrating a collateral allocation system in accordance with an embodiment of the invention;

FIG. 4 is a block diagram illustrating front end interactive components in accordance with an embodiment of the invention;

FIG. 5 is block diagram illustrating collateral flow between participants in accordance with an embodiment of the invention;

FIG. 6 is a flow chart illustrating the use of eligibility requirements during allocation in accordance with embodiments of the invention;

FIG. 7 is a flow chart illustrating an allocation process in accordance with an embodiment of the invention;

FIG. 8 is flow chart illustrating a process of allocation by asset in accordance with an embodiment of the invention;

FIG. 9 is a flow chart illustrating a process of allocation by lender in accordance with an embodiment of the invention;

FIG. 10 is a screen shot illustrating a display of participant positions in accordance with an embodiment of the invention;

FIG. 11 is a screen shot illustrating an additional display of participant positions in accordance with an embodiment of the invention; and

FIG. 12 is a block diagram illustrating a computing environment that may be incorporated in accordance with embodiments of the invention.

### DETAILED DESCRIPTION OF PREFERRED EMBODIMENTS

Embodiments of the present invention are directed to a collateral management system that operates across multiple products and implements multiple types of selectable allocation runs. The collateral management system incorporates a rehypothecation engine for re-using received collateral that allows lenders to generate returns on held assets rather than holding a long inventory. For borrowers, the rehypothecation engine facilitates collateral upgrade trades.

A goal of collateral allocation is to allocate securities as collateral from participant long boxes and collateral accounts to lender collateral accounts, both maximizing the rehypothecation of received collateral and optimizing the use of borrower's own, fresh collateral. The allocation system may, in embodiments of the invention, have functionality similar to that described in commonly owned U.S. Pat. No. 7,480,632 to Fudali et al, which is hereby incorporated by reference. However, the allocation system in accordance with embodiments of the invention includes improved and enhanced functionality, which will be explained in detail below.

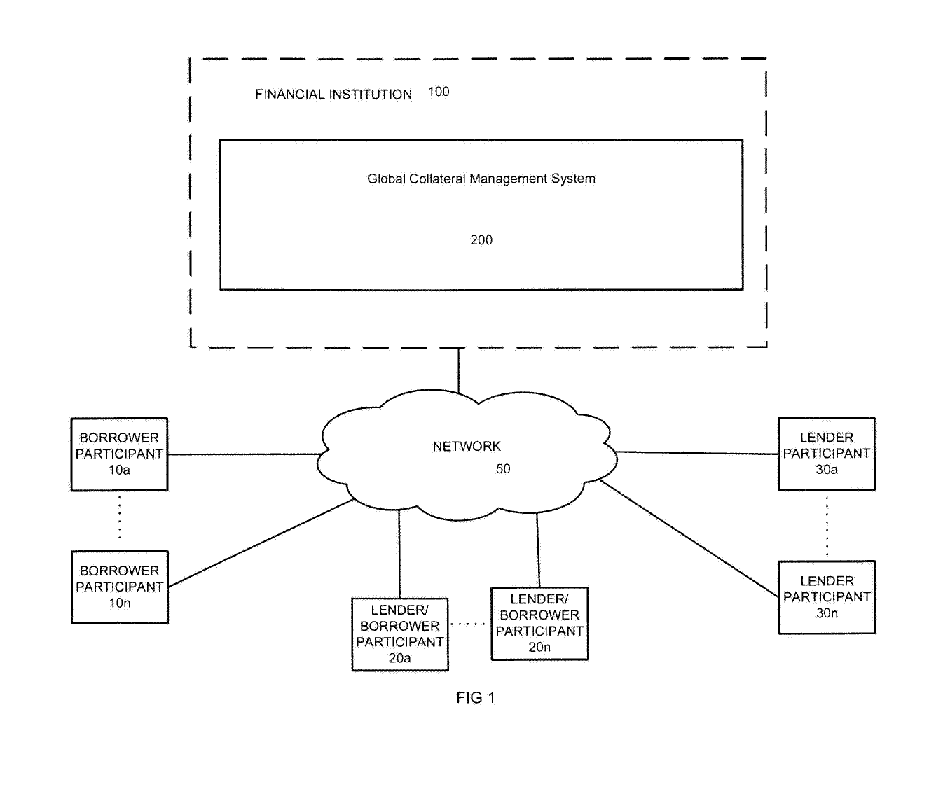

FIG. 1 is a block diagram illustrating an operating environment for global collateral management system 200 in accordance with an embodiment of the invention. The global collateral management system 200 may be operated by a financial institution 100. The financial institution 100 and global collateral management system 200 may be connected over a network 50 with system participants. The system participants may include borrower participants 10a . . . 10n, lender/borrower participants 20a . . . 20n, and lender participants 30a . . . 30n. Participants are enrolled in the global collateral management system 200 and are actively involved in collateral management.

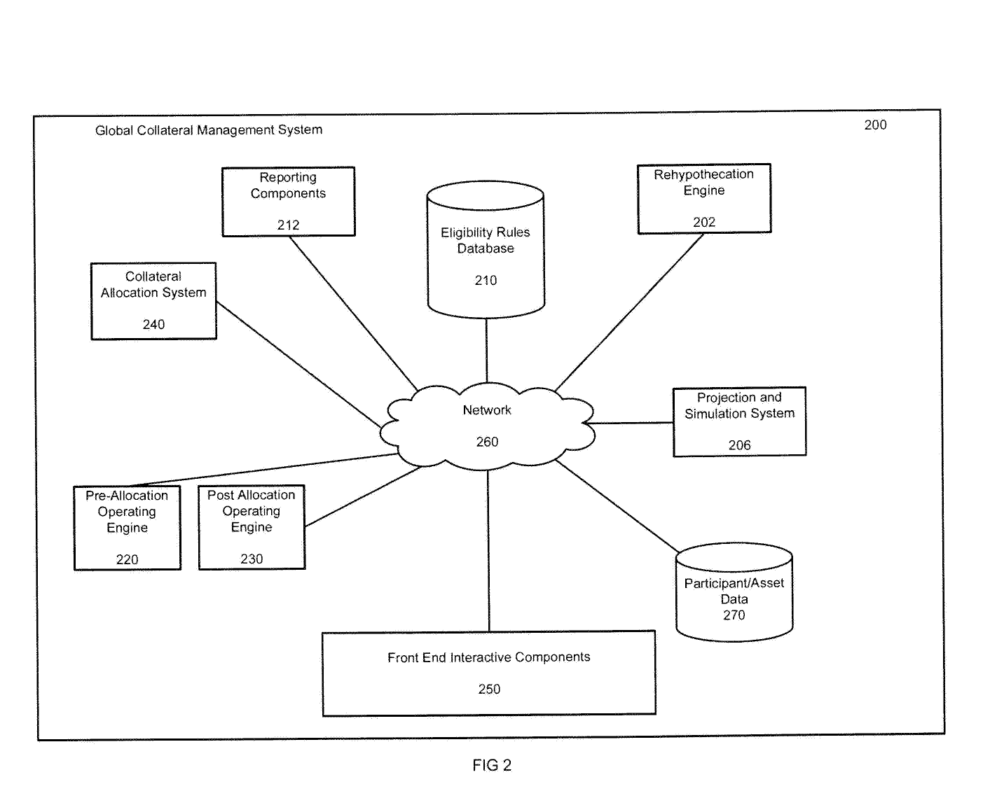

Borrower participants 10a . . . 10n are collateral providers and lender participants 30a . . . 30n are collateral receivers. Lender/borrower participants 20a . . . 20n are participants who both receive collateral and provide collateral. Thus, the lender/borrower participants 20a . . . 20n re-introduce assets that they have received in their role as lenders. Lender/borrower participants 20a . . . 20n enrolled in the system actively re-use assets received through the lending business. Despite the fact that in order to participate, parties must be enrolled in the system, the financial institution or other organization operating the collateral management system 200 can operate on assets that it does not hold as long as the parties grant contractual control over the assets. Storage of the assets will be further described below with reference to FIG. 2.

Network 50 may include various networks in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a networking environment, computers may include a communication mechanism. Communication devices may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

FIG. 2 is a block diagram illustrating the global collateral management system 200 in accordance with an embodiment of the invention. The global collateral management system 200 is shown as including a rehypothecation engine 202, a projection and simulation system 206, eligibility rules database 210, reporting components 212, a pre-allocation engine 220, a post allocation engine 230, a collateral allocation system 240, front end interactive components 250, and participant/asset data 270. All of the aforementioned components may communicate over a network 260. Alternatively, the components may be integrated or may communicate over multiple networks.

The rehypothecation engine 202 is described in greater detail in co-pending application PCT US09/52420, which has been incorporated herein by reference. In summary, rehypothecation refers to the reuse of collateral received from one counterparty to satisfy the collateral requirements from another counterparty. Thus, participating collateral receivers have the capability to become lender/borrowers or rehypothecators because they are given the ability to use collateral they have received to meet collateral obligations they may have where they are a collateral provider.

The projection and simulation system 206 performs hypothetical allocation runs to allow borrowers and lenders to view a post allocation snapshot given hypothetical preferences for lenders, assets, types of allocation runs, etc. The projections and simulation system 206 does not perform an actual allocation and instead merely serves as a valuable informational tool for system participants.

The eligibility rules database 210 may include rules input both by lenders and borrowers regarding eligibility of assets for allocation. Eligibility parameters are the parameters established to identify acceptable collateral. The parties specify the types of collateral they are willing to accept or allocate. Furthermore, the eligibility rules database 210 may include concentration limits established by lenders. Concentration limits specify the quantity or percentage of that collateral in relation to the outstanding required value (RQV) or issue amount to be met with collateral from the borrower. The participants may have the ability to specify, where appropriate, a number of shares as the concentration limit in addition to the ability to specify by amount (in any currency) or by percentage. Furthermore, in embodiments of the invention, lenders have the ability to specify concentration limits on a number of factors including line, country, region, issuer, industry sector, issue rating, issuer rating, maturity range, and asset type. The capability may also be provided to specify concentration limits per deal (which may include an individual loan), cross deal, cross account, and cross counterparty account.

The reporting components 212 may generate and provide participants with a variety of reports. The reports may include, for example, a headroom report, which illustrates how much further borrowing the borrower's remaining assets would support. The reports may further include information pertaining to unutilised concentration limits which the borrower can specifically target by bringing in relevant assets. Reports may further enable participants to have the ability to trace back the settings that dictate whether a specific asset has been deemed eligible or ineligible and has been allocated to a specific lender and also if the concentration limit was breached and what limit was breached. The reporting components 212 may further provide an optimisation matrix, which facilitates the efficiency of collateral providers. Using this information, borrowers can determine which asset would be the most optimal portfolio to meet their lender commitments. Furthermore, after an allocation run has completed, the reporting components 212 may produce a report that articulates which assets are ineligible across the entire lender universe. Such a report allows borrowers to group assets logically so that they can negotiate eligibility with their lenders.

Users will also have access to real-time self-service reporting and inquiry management. So that service representatives may be fully utilized, the platform will provide these representatives with a remote desktop capability so that the representatives can see the interface. The user interface is designed to enable participant initiation of transactions and simplified viewing of activity. The reporting may encompass eligibility schedules, real and hypothetical allocations. Other reports useful to system participants may also be generated.

The participant/asset data 270 may include information accessed by the allocation system to determine an appropriate allocation of assets. Such information may include, for example, asset locations, global long box information, external long box information, notional long box information, and other information relevant to user assets and the location of the assets. Within the collateral management system, the storage of participant/asset data 270 may be or include a global long box, which that permits aggregation of cash and securities collateral balances for a participant across regions and collateral management products. The global long box serves as a custody or holding account into which assets are delivered for eventual allocation, whether this be for real or hypothetical. The stored collateral may be allocated or available, already in the host system or on its way in, or pledged to counterparties of participants and held outside the host system. The global long box is agnostic of underlying custody platform or asset class. For example, the assets may include stocks, loans, structured deals, repurchase agreements, or secured credit lines.

The participant/asset data 270 may also include a notional long box, which is not a physical long box, but a representation of a long box for housing assets that have been allocated from different borrowers, so that these assets can be used by participants for rehypothecation. The participant/asset data 270 may further include or access escrow accounts held by participants and independent third parties. Additionally, the participant/asset data may include or access external long boxes held outside of the collateral management system. Furthermore, the participant/asset data may include or access one or more shared long boxes jointly owned by participants or other legal entities.

In embodiments of the invention, the global long box stores both external and internal assets and allows participants to view both sets of assets. Participants may be able to access both internal and external assets through the global long box or alternatively, while being able to view both internal and external assets, the participants may be restricted to access internal assets only. Access to external assets may be provided through an alternative interface. In yet further embodiments of the invention, internal and external assets may be both stored and accessed through separate long boxes, both accessible to the collateral management system.

The pre-allocation engine 220 controls pre-allocation activity. The allocations process is to be preceded by pre-allocation activity, which is necessary for bringing in external assets and hypothetical assets. The pre-allocation engine captures a pre-allocation snapshot in order to value the existing collateral at the current market prices. The pre-allocation engine may further conduct a threshold tolerance check and a minimum transfer amount check to ensure that the allocation run can be conducted. Other pre-allocation activities include checking for a simulation run and upon the finding of a simulation, retrieving hypothetical assets. If the pre-allocation engine confirms that the run is not a simulation run, the next steps are to lock collateral accounts and to lock collateral credit lines. This is to be followed by the check to see what variation of run is requested.

The post allocation engine 230 operates upon completion of the allocation run to record a post-allocation snapshot. This is to be followed by netting, where the differences between the pre and post allocation snapshots are to be evaluated, thus identifying the potential movements of assets.

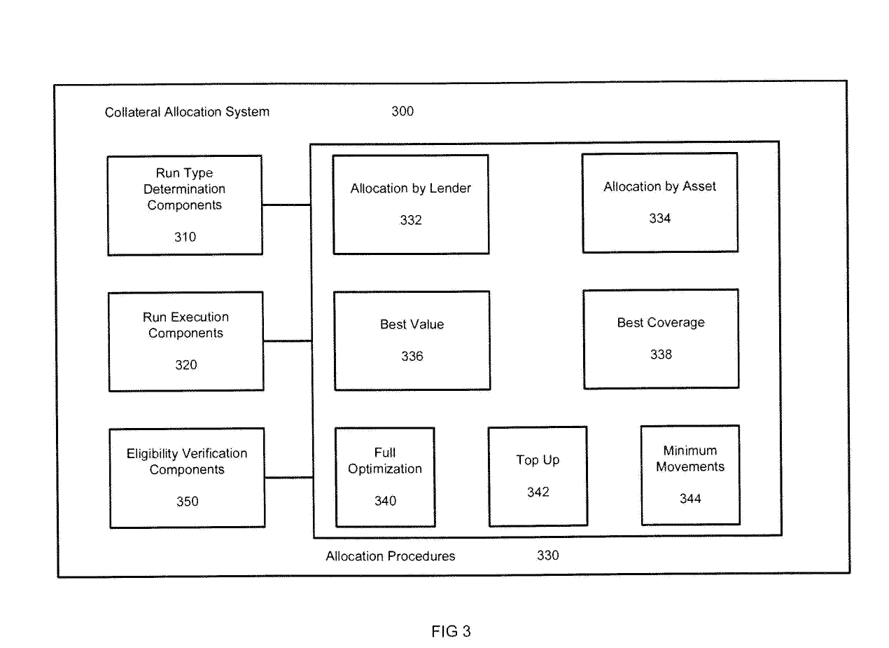

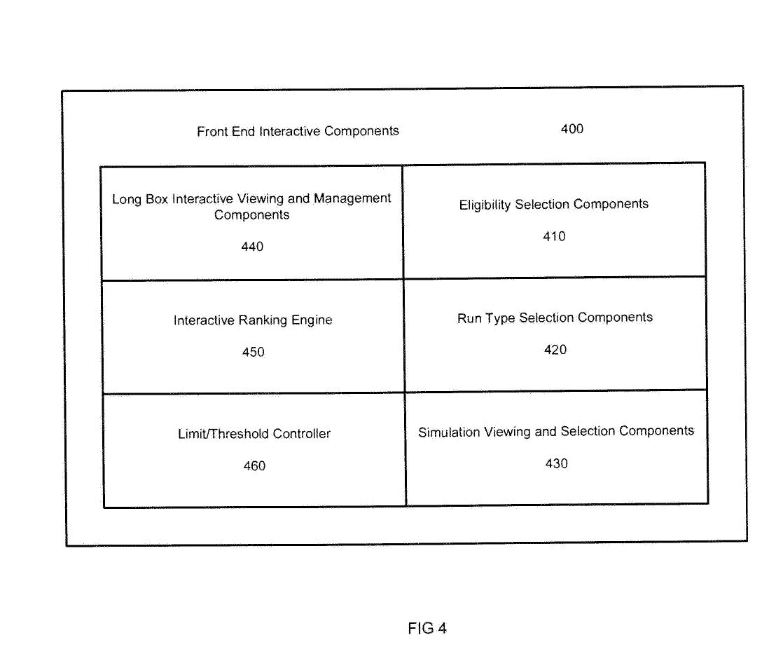

The collateral allocation system 240 includes components implemented during an allocation run. The collateral allocation system 240 is illustrated in greater detail in FIG. 3. The front end interactive components 250 provide system participants with a user interface for selecting parameters such as eligibility constraints and allocation run types. The front end interactive components 250 further provide borrowers with the ability to view meaningful long box representations. The front end interactive components 250 are illustrated in greater detail with reference to FIG. 4.

FIG. 3 is a block diagram illustrating a collateral allocation system 300 in accordance with an embodiment of the invention. The collateral allocation system 300 may include stored allocation procedures 330 executed by a computer processor in order to allocate assets. The stored allocation procedures 330 may include allocation by lender 332, allocation by asset 334, best value 336, best coverage 338, full optimization 340, top-up, 342, and minimum movements 344. The collateral allocation system 300 may additionally include run type determination components 310, run execution components 320, and eligibility verification components 350.

In operation, the run type determination components 310 may access stored procedures based on preferences stored in the eligibility database as verified by the eligibility verification components. Run execution components 320 may be implemented to combine or integrate selected procedures for executing an allocation run.

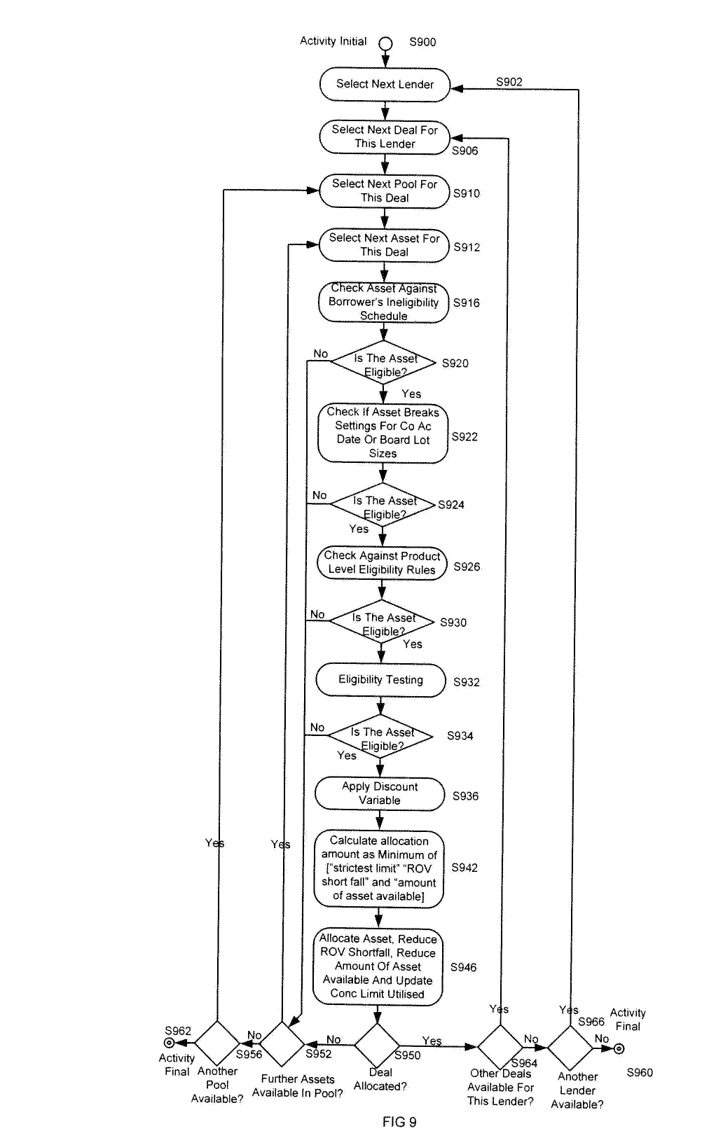

All of the aforementioned allocation procedures may be selected by borrowers based on personal preference. Allocation by lender procedures 332 and allocation by asset procedures 334 may be selected by the borrower based on personal preferences. In allocation by lender procedures 332, the first step may be lender selection. The ordering of the lenders will be influenced by any selections that the borrower has made to highlight some lenders who are to be allocated at a priority, and the goal of the run (e.g. whether best coverage, best value, etc.) Allocation by lender is further described with reference to FIG. 9 below.

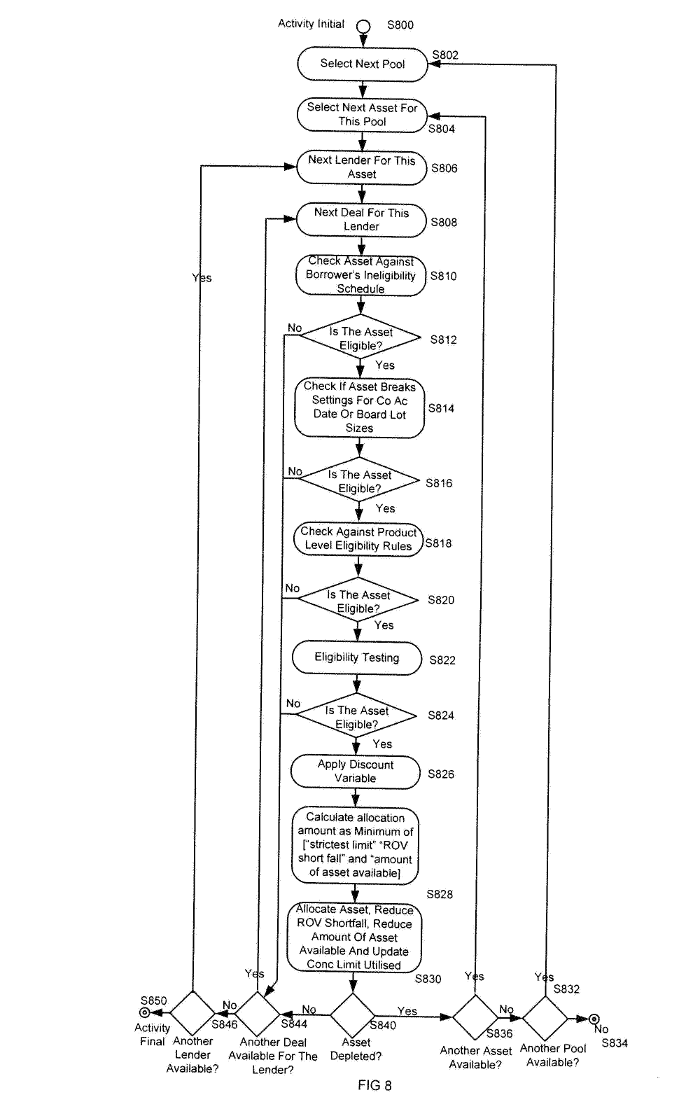

The allocation by asset procedure 334 first selects a pool of assets. The ordering of the pools is driven by the borrower's prioritisation. Allocation by asset is further described below with reference to FIG. 8.

In order to achieve full optimisation with optimization procedures 340, the borrower will be able to specify the goal of the run in accordance with either best value procedures 336 or best coverage procedures 338.

With best value procedures 336, the asset could be allocated first to the lender that values it the highest, and then to other lenders, moving in descending order of value given to the asset. Optimisation with the goal of achieving best value entails covering the accounts while obtaining best value for the assets (e.g. lowest haircuts is the primary consideration, and coverage is the second.) Haircuts refer to the practice of valuing an asset at a percentage of market value as perceived by the collateral receiver due to market volatility. In embodiments of the invention, for best value procedures 336, borrowers may select one or more lenders to be allocated at a priority and the remainder of the lenders may be addressed by the optimized best value procedures in which the system attempts to cover the accounts while obtaining best value for the assets. Thus, for optimized best value procedures, obtaining lowest haircuts is the primary consideration and coverage is secondary. In the absence of lender selections, lenders are automatically ranked so as to achieve this goal.

Best coverage procedures 338 aim to achieve 100% lender account coverage from the existing asset pool. When implementing best coverage procedures 338, coverage is primary and value is secondary. The priority is to use all of the borrower's existing asset pool as collateral. In an optimized scenario, lenders are automatically ranked by the system so as to achieve this goal.

For top up run procedures 342, specific accounts can be collateralized using only long box positions including external long boxes, while not disturbing accounts that have already been collateralised. For the top up run allocation runs, long box positions are retrieved, and assets are locked in escrow accounts. A top up run is a type of allocation run that keeps existing positions locked in place and allocates from the long box.

With minimum movements procedures 344, the goal is to achieve collateralisation of the deals while requiring a minimum number of movements. Thus, minimum movements procedures calculate the best allocation based on the minimum amount of movements to assets.

In preferred embodiments, for all types of run procedures described above, the borrower will be able to prioritise, de-prioritise, include, or exclude external long boxes, and have the ability to include and exclude recalls and credit. In embodiments of the invention, these selections may be applied at a specified time of day or up to market cut off time.

FIG. 4 is a block diagram illustrating front end interactive components 400 in accordance with an embodiment of the invention. Via one or more user interfaces accessing the front end interactive components 400, system participants will be able to add assets easily and quickly to the global longbox. Additionally, participants will be able to select through their interfaces, which assets they would like to allocate across and in what order. The allocation of assets is further configurable in that multiple runs can be performed, such that each run is specific to a product, or alternatively, a single run can be performed across all products.

The front end interactive components 400 may include eligibility selection components 410, run type selection components 420, simulation viewing and selection components 430, long box interactive viewing and management components 440, interactive ranking engine 450, and limit/threshold controller 460.

Eligibility selection components 410 may be available to both borrowers and lenders and may provide the opportunity for both counterparties to adjust eligibility settings. The eligibility selection components 410 may allow lenders to specify eligibility criteria by detailing the assets that they will accept. An interface may be provided to allow lenders to designate eligibility at a product level, so that certain assets may be considered ineligible across all participants. The eligibility selection components 410 may provide lenders with self-service capability allowing them to set up eligibility schedules. Alternatively or additionally, an interface may be provided through the financial institution at an administrative level in order to allow setup on behalf of the participant. Additionally, the eligibility selection components 410 allow borrowers to specify the assets that they would like to be considered as ineligible. Borrowers may designate individual assets or an entire class of instruments as ineligible or as unavailable to specific lenders. Both the borrowers and the lenders will be able to independently view the actual eligibility schedule that is in force, the pending changes, and for the pending changes, an indication of when they will be effective. A web and a graphical user interface will allow participants to view positions via the web and to input and manage the eligibility data across all collateral management products. From the user interface, the user may be able to make adjustments to eligibility criteria definitions during the trading day.

Furthermore, the eligibility selection components 410 may offer the self service capability for borrowers to lock assets to nominated accounts and for lenders to unilaterally lock account from movements, via self service, for specified time. For example, lenders may want to restrict hours so as to eliminate movements after a specified time of day.

Run type selection components 420 are implemented to select a run-type based on input preferences. Multiple run-types are described above with reference to FIG. 3. These run types may, in some instances be combined. In embodiments in which customized run types are available, the opportunity to customize is provided through the run type selection components 420.

Simulation viewing and selection components 430 provide the ability to carry out simulations to enable borrowers to execute runs that mirror actual runs without performing actual physical movements. Having the ability to view results in advance of the movements provides a useful instructional borrower tool. In preferred embodiments of the invention, after completing a simulation run, the borrower is to be able to execute based on the settings for the simulation by simply instructing the system to apply the simulation settings through the simulation viewing and selection components 430. The simulation viewing and selection components 430 may further provide a summary to participants showing the differences between the simulation runs and the actual runs. To further investigate issues that are highlighted in the summary, the borrower will be able to look into all transactions from an applicable long box.

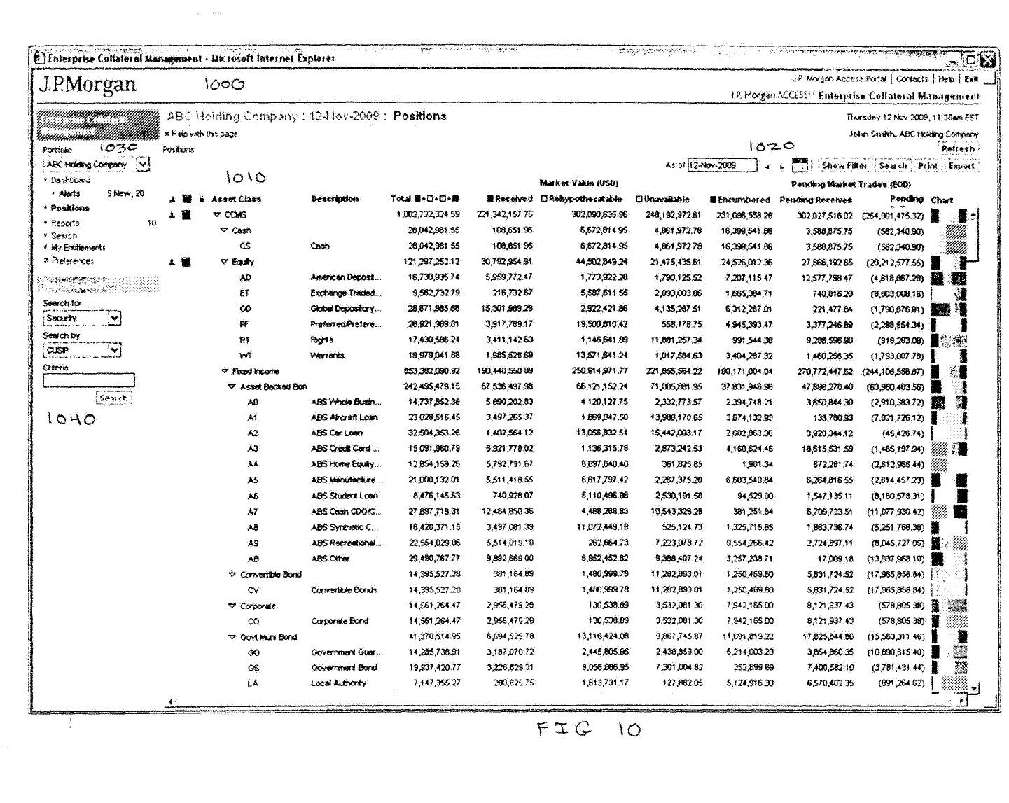

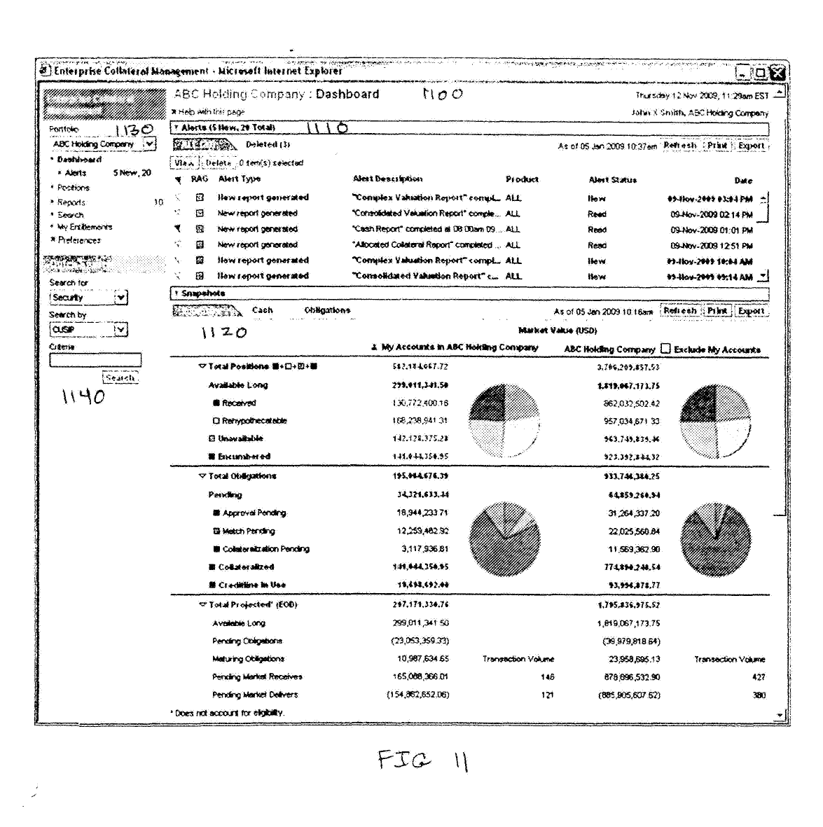

Long box interactive viewing and management components 440 may provide a window into assets into long boxes, including external long boxes. A view into the global long box would be able to show all assets stored in the global long box housed within the collateral management system that belong to a participant, across geography and across products. External long boxes may be stored outside of the collateral management system. However, participants may provide the collateral management system with access to these external long boxes both for allocation of collateral and for viewing. The viewing capabilities further enhance selection capabilities that allow participants to have the flexibility to carry out allocation while including, excluding, prioritising, deprioritising, or mingling assets in one or many internal or external long boxes. FIGS. 10 and 11, which will be described below provide further details of the long box interactive viewing components 440.

Interactive ranking engine 450 allows borrowers, who are the collateral providers, to use collateral types as the basis for assigning a relative quality of collateral or a borrower quality ranking “BQR”. In preferred embodiments, borrowers have the capability to be able to update their ranking of assets intraday, and to allow multiple settings to be changed through the day. Thus, the borrower is successfully able to specify its own order for sorting the assets, thereby overriding any existing system default order.

Lenders, who are the collateral receivers, use the collateral type to define eligibility and may also associate concentration limits against them. Borrowers may be provided with the ability to rank assets from ‘Allocate first’ to ‘Allocate last’. The Borrower will typically want to allocate the lowest quality stock it has to lenders first and then move up the scale. In embodiments of the invention, borrower quality rankings range from 0.01 being the lowest and 99.99 being the highest. In additional embodiments, other ranking schemes may be implemented. The capability may be provided to drag and drop rankings through the user interface.

Limit/threshold controller 460 enables a threshold test that is based on the credit rating of a counterparty, to be used prior to allocation run. In embodiments of the invention, concentration limits may fall into four groups including: (a) cross account group concentration limits; (b) cross account concentration limits; (c) group concentration limits; and (d) concentration limits. All four of these limits can apply in turn. The system evaluates each asset to ensure that the strictest of the limits is not broken and to ensure that none of these limits is broken individually. For example, a set of lender accounts could be part of a cross account group concentration limit. Once the group of accounts has reached its limit, then no more collateral can be allocated even though the individual accounts' concentration limits have not been reached. An additional check involves calculation of the amount of collateral that can be allocated. The system allocates the asset by board lot size while observing the concentration limits, calculates the collateral value of the asset it has allocated, and reduces the collateral total accordingly. The asset movement is recorded (i.e. source and destination accounts). The system further examines remaining assets by establishing if all of the holding has been allocated. If there is any holding in the asset remaining, it will be assessed against the next lender. A further check ensures that the RQV has been reached.

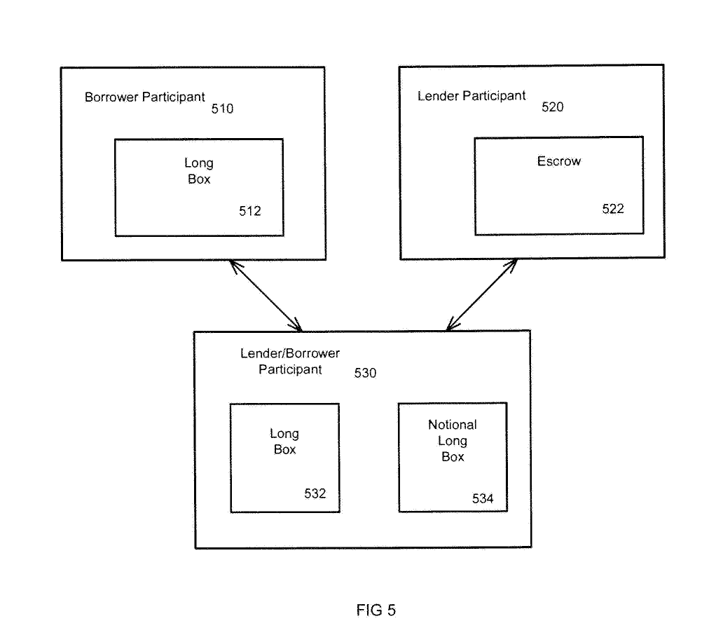

FIG. 5 is block diagram illustrating collateral flow between participants in accordance with an embodiment of the invention. A lender participant 520 having escrow 522 is shown. A borrower 510 stores assets in a long box 512, which in preferred embodiments of the invention is a global long box which stores assets across products and geographies. The long box 512 may additionally include multiple long boxes including both internal and external long boxes. The assets in the long box 512 are available as collateral to a lender/borrower participant 530.

The lender borrower 530 is a participant engaged in rehypothecation of assets. The lender borrower 530 may have both a long box 532 and a notional long box 534. The notional long box 534 is a pool of assets that is made up of the securities held in the lender/borrower's escrow accounts, i.e. those assets the borrower/lender participant 530 has received as part of lending activity and is willing to re-use to satisfy its own borrowing obligations. Borrower/lender participants 530 can decide which escrow accounts they wish to include in the notional long boxes 534. The notional long box 534 contains all the re-usable assets for a given lender/borrower. In embodiments of the invention, during rehypothecation, participants cannot re-use the same piece of collateral more than once. Once a participant has enrolled, the system treats all the assets the participant has delivered as a single portfolio of assets. As set forth above, more detail on the rehypothecation is contained within related application PCT Application Serial No. PCT US09/52420, filed on Jul. 31, 2009, as well as U.S. Provisional Application Ser. No. 61/085,563.

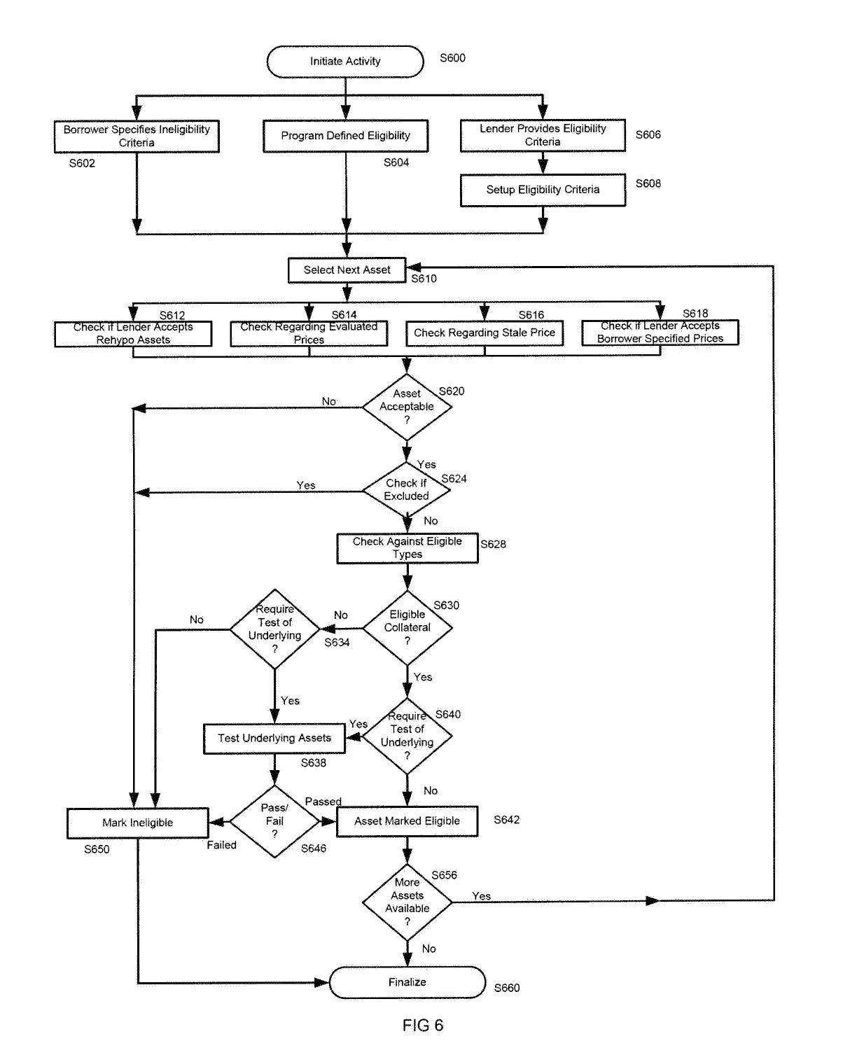

FIG. 6 is a flow chart illustrating the use of eligibility requirements during allocation in accordance with embodiments of the invention. In S600 eligibility activity is initiated. Initial steps include the definition of eligibility criteria. In S602, the borrower specifies assets that it would like considered as ineligible. In S604, a definition is provided at a product level of assets that will be considered ineligible across all participants. This product level definition may be an internal system definition or may be established by the lender. The full functionality, described below, which is available to a lender for specifying eligibility criteria will also be available when specifying eligibility criteria at a product level. In S606, the lender will specify eligibility criteria, detailing the assets that it will accept. The lender will have self-service capability allowing it to set up eligibility schedules on its own. Alternatively, as shown in S608, lenders may provide specifications for system administrators who may execute the settings on behalf of the lenders. Although described sequentially, steps 602, 604, and 606 may be performed simultaneously or in any order. Ultimately, both the borrower and the lender will be able to independently view the actual eligibility schedule established by these steps as well as the pending changes, and for the pending changes—an indication of when they will come into force. Furthermore, in embodiments of the invention, both the borrower and the lender will be provided with the option to provide an approval sign-off online. At each borrower-lender relationship level, the system provides the ability to control settings regarding approval sign-offs, which may not be required in all situations. S602, S604, S606, and S608 are preferably executed manually with user input and are followed by automated steps performed by the system as set forth below.

In S610, the system selects an asset. Steps S612, S614, S616, and S618 implement various checks against each selected asset. S612 checks to see if the lender accepts received rehypothecated assets. S614 implements a check regarding evaluated prices. S616 checks regarding stale prices. Step 618 checks to see if the lender accepts borrower-priced assets. Based on the outcome of these checks, the asset may be considered unacceptable or acceptable.

The system checks in S620 to determine if the asset is acceptable. If the asset is not acceptable in S620, it is to be marked as ineligible in S650 and a check made to see if any other assets are available in S656. If other assets are available in S656, the next asset is to be selected in S610 and the process started again. If no other assets are available, the process is to be ended in S660, the system having tested all available assets.

The selected asset is to be tested in S624 against the lenders and the borrowers criteria for excluded assets. In the above test, if the asset matches up with the list of excluded assets it is to be marked as ineligible as set forth above and a check made to see if any other assets are available. If other assets are available, the system selects the next asset and the process repeats. If no other assets are available, the process ends, having tested all available assets.

In the test of S624, if the asset does not match up with the list of excluded assets, the system tests against the criteria for eligible assets in S628. Based on the outcome of the test against the criteria for eligible assets, and on the setting for the underlying flag for the asset, a further test is to be conducted for underlying assets in S634 and S640. In some scenarios, whether the asset has passed or failed the test against the criteria for eligible assets, the test for underlying assets is to be carried out. However in other scenarios, only one of the tests of S634 and S640 may be necessary.

The outcome of the test for underlying assets would either be that the asset passes and is marked eligible in S642, or that the asset fails and it is marked ineligible in S650. In either case, the next step is to check if any other assets are available in S656. If other assets are available, the next asset is selected and the process starts again in S610. If no other assets are available, the process ends in S660, as all available assets have been tested.

The eligibility criteria will be specified using a rules based approach similar to the manner in which email users specify rules for managing incoming email. In a preferred embodiment, the rules are configured in a tree format, starting with an asset type, and descending multiple levels, with multiple forks en route, as further granularity is specified. A similar tree structure may also be used to specify concentration limits and haircuts. The rules based approach allows the participants to specify exactly what assets it will accept, without having to separately call out exclusions.

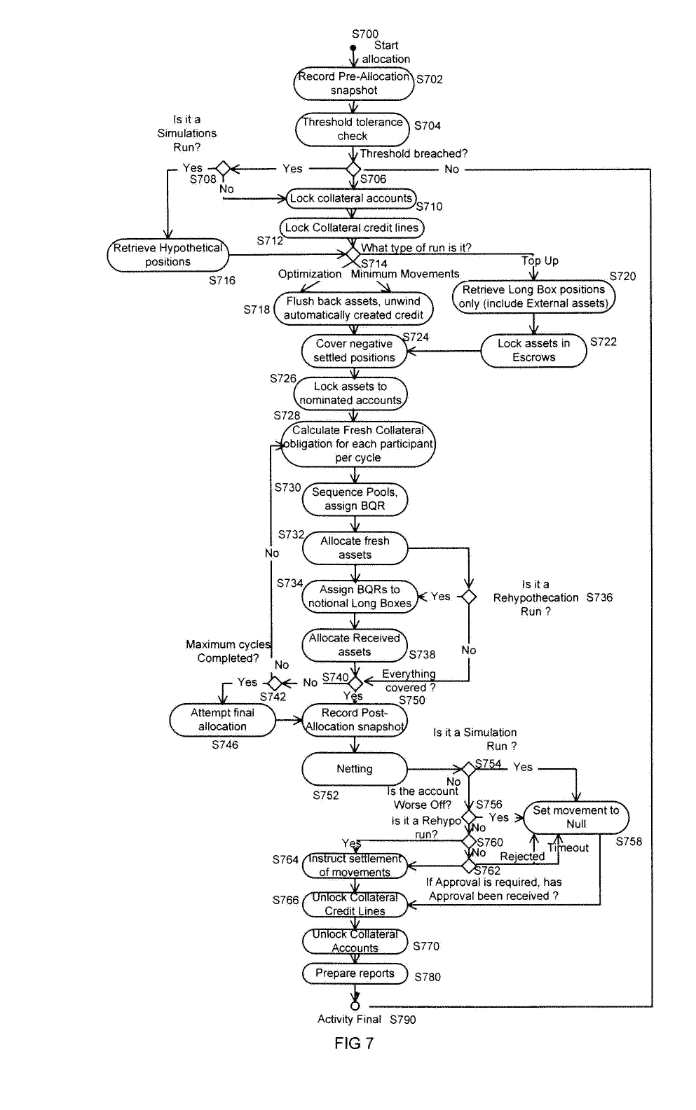

FIG. 7 is a flow chart illustrating an allocation process in accordance with an embodiment of the invention. Each allocation is preceded by pre-allocation activity, which is necessary for bringing in external assets and hypothetical assets. When an allocation is requested in S700, a pre-allocation snapshot is captured in S702. The pre-allocation snapshot shows the valuing of the existing collateral at the current market prices. To support the bi-lateral margining process of calling for margin, or difference between an account value and RQV, only if an agreed threshold is breached, a threshold tolerance check and a minimum transfer amount check are carried out in S704.

If the threshold is breached in S706, the system checks for a simulation run in S708. If the run is a simulation run, then the next step is to retrieve hypothetical assets in S716. Following the retrieval of hypothetical assets in S716, the system checks for type of run in S714. Simulation runs can be carried out for the top-up, minimum movements, and optimization runs, and in embodiments of the invention, simulation runs can be performed for rehypothecation. In this instance, rehypothecation simulations will be independent for each participant and a simulation by one participant will not impact a simulation performed by another. Regardless of the type of run, after completing a simulation run, the borrower will be able to execute based on the settings for the simulation run, except where hypothetical positions have been involved, in which case there it will be necessary to wait for the assets to be available.

If confirmed that the run is not a simulation run in S708, the next steps are to lock collateral accounts in S710 and to lock collateral credit lines in S712. This is to be followed by the check to see what variation of run is requested in S714. Apart from the simulation run that has already been addressed, at least three basic run variations are provided as selectable options to the borrower. These selectable options, which were described in detail above with respect to FIG. 4, include at least, optimization, top up, and minimum movements runs.

After executing the optimization or minimum movement runs and flushing back assets and unwinding automatically created credit in S718, the system covers negative settled positions in S724. Furthermore, if a top up run is performed, the system retrieves long box positions in S720 and locks assets in escrow in S722 before negative settled positions are covered in S724. The system then addresses negative settled positions in S724 by placing assets in the lender long box or other accounts to cover negative settled positions. The system locks assets to nominated accounts in S726 as requested by the borrowers, so that these locked assets will not be considered for optimisation. In S728, the system calculates the minimum fresh collateral amount that each participant has available to introduce for the specific cycle. This calculation can be carried out multiple times as required, but will be limited by a specified number of maximum allowed cycles. For a tri party repo transaction in which an independent agent bank or clearing house oversees a standard two party repo transaction, the calculation will only be carried out once, and will indicate that the borrower is responsible for providing 100% of the fresh collateral.

The borrower may specify the order in which different sources of assets are to be considered during the allocation process in S730. The different pools that can be considered would be: (1) Available; (2) Unavailable; (3) Reserved for market trades; (4) Reserved for Internal trades; (5) External Long Boxes; and (6) Projections and Simulations Assets; and (7) Credit.

Available pools with reference to item (1) above are those that are ready for use by the allocation algorithm. Unavailable pools with reference to item (2) above includes long box collateral that cannot be use for allocation, e.g. a market delivery pending settlement. Reserved for market trades with reference to item (3) above refers to trades received from borrower but not yet instructed to market. With reference to item (4), the pools reserved for internal transfers include inter-account movements instructed by borrower. With reference to item (5), external long box pools may include assets from external long boxes other than the borrower global long box integrated with the system. With reference to item (6), projection and simulation assets or cash includes those assets used for projections and simulations as well as cash. With reference to item (7) embodiments of the invention may also be used as an asset pool during allocation.

In S732, the order of selection will drive the process of allocating fresh assets. The system will order the assets within each pool based on the borrower's specified BQRs. Fresh assets will then be allocated, based on the sequence of pools described above. This activity is described below in further detail. As will be further described, two fundamental approaches involve first selecting a lender, and allocating to all of its deals by cycling through available assets in the available pools, and alternately, by first selecting an asset and allocating it to various deals of different lenders before moving on to the next asset.

In S736, the system will check to see whether the selected run is a rehypothecation run. If it is not a rehypothecation run, the system will check for coverage in S740. Additional allocation will be performed in S746 if everything is not covered.

If the run is a rehypothecation run in S736, the system address received assets by assigning the introducer's BQRs to the notional long boxes. A borrower could have numerous notional long boxes, each carrying assets received exclusively from one other individual rehypothecation participant. In S738, the system allocates the received assets. In S740, the system checks to see if everything is covered. If all items are not covered in S740, a check for completion of maximum cycles is to be carried out in S742. If everything is covered in S740, the next step will be to record a post-allocation snapshot in S750.

In evaluating the completion of maximum cycles in S742, the system determines if it will be possible to carry out another cycle. If the maximum cycles have not been completed in S742, then it is possible to run another cycle in S728. If the maximum cycles have been completed, then the next step will be to attempt final allocation in S746.

The final allocation attempt of S746 will aim to complete the collateralisation using fresh assets only, effectively abandoning any further attempts at rehypothecation. However, if collateralisation is not achievable using fresh assets only, credit can be obtained as the final alternative.

Following the allocation of S738 or S746, the next step is to record a post-allocation snapshot in S750. Netting follows in S752 where the differences between the pre and post allocation snapshots are to be evaluated, thus identifying the potential movements of assets.

Before either the instruction of any movement of assets, or the setting of movements to null, a number of checks are to be performed. First there will be a check to see if it is a simulation run in S754. If it is a simulation run in S754, then account movements are to be set to null in S758, effectively abandoning any changes to the account. If it is not a simulation run in S754, the next check will be to see if the account will be left worse-off in S756.

If the account will be left worse off in S756, then the movements are to be set to null in S758. If the account is not worse off, the next check will be to see if the run is a rehypothecation run in S760. If the run is a rehypothecation run in S760, the next step will be to instruct the settlement of movements to the target platforms. If the run is not a rehypothecation run in S760, the next check is whether approvals have been received in S762 in the case that third party approvals are required.

If third party approvals are required and the request for third party approval either times out or is rejected, movements are set to null. If the request for third party approval is approved, the next step instructs the settlement of movements to the target platforms in S764.

Subsequently, the system unlocks the previously locked credit lines in S766 and collateral accounts in S770. Ultimately, the system prepares reports based on the allocation in S780. The reports will be able to present information captured within the allocation process. The process finishes in S790.

Within this allocation process, a number of steps may be taken in the case of default. The pre-allocation snapshot records the default and the defaulting participant is not included in the ‘calculate fresh’ activity. The system locks the assets, records and freezes the value of collateral, and maintains the value independent of changes in market value.

FIG. 8 is flow chart illustrating a process of allocation by asset in accordance with an embodiment of the invention. The process begins in S800 and the pool of assets is selected in S802. As described earlier, the ordering of the pools is driven by the borrower's prioritisation. Sources may include the global long box, notional long boxes, external long boxes, assets reserved for market trades, assets reserved for internal transfers, projection and simulation positions, cash, credit, or other sources. Having selected the pool, the system identifies the next asset within this pool in S804.

In S806, the system identifies the next lender. The ordering of the lenders may be influenced by several factors. One factor is the selections that the borrower has made to highlight some lenders to be allocated at a priority. The system additionally considers the goal of the allocation run, e.g. whether best coverage, best value, etc. Having selected the lender in S806, the system identifies the next deal for this lender in S808. In S810, the system tests the selected asset against the borrower's ineligibility schedule that identifies assets which the borrower has designated ineligible. If the asset matches criteria specified, it is considered ineligible in S844.

If the asset is considered ineligible in S844, the system determines if there are further deals available with this lender. If further deals are available in S844, the next deal is selected in S808 and the process repeats. If there are no more deals available with this lender in S844, the system determines if there are further lenders available in S846. If lenders are available in S846, the system selects the next lender in S806 and repeats the above-described process. If no more lenders are available in S846, the process ends in S650, as the system has tested all available deals with all available lenders.

If the asset is considered eligible in S812, the system tests the asset against corporate action dates and board lot sizes in S814. If the test fails in S816, the system again searches for more deals or more lenders. If the test of S814, succeeds, the system tests against product level eligibility rules in S818. If the asset fails to meet these product level eligibility criteria, it is considered ineligible in S820. If the asset is considered ineligible in S820, the next step will be to check if there are further deals available with this lender in S844. If additional deals are available in S844, the process described above repeats. If there are no more deals available with this lender, the next step will be to check if there are further lenders available in S846. If further lenders are available, the system selects a lender in S806 and the process described above repeats. If no further lenders are available, the process ends in S850.

If the asset is considered eligible in S820, the system conducts eligibility testing against lender selected eligibility criteria in S822. If the asset fails to meet the lender specified eligibility criteria in S824, it is considered ineligible.

If the asset is considered ineligible in S824, the next step will be to check if there are further deals available with this lender in S844. If additional deals are available in S844, the process described above repeats. If there are no more deals available with this lender, the next step will be to check if there are further lenders available in S846. If further lenders are available, the system selects a lender in S806 and the process described above repeats. If no further lenders are available, the process ends in S850

If the asset is considered eligible in S824, the system applies the appropriate discount variables in S826. Subsequently, in S828, the system identifies the amount of the asset that will be allocated. This amount may be calculated as the minimum of: (1) the available amount of the asset; (2) the strictest concentration limit applicable to the asset; or (3) the RQV shortfall.

In S830, the system allocates the asset and updates records. The updated records may reflect reduction in the record of the available amount of the asset, reduction in the record of the RQV shortfall, and/or an update to the record regarding the amount of concentration limit utilised.

After the updates, in S840, the system determines whether the asset has been depleted. If the asset has not been depleted in S840, the system determines if further deals are available with the lender in S844. If yes, the next deal is to be selected and the process repeats. If there are no more deals in S844, the system checks for additional lender in S846 and if there are additional lenders available, the process repeats. If not, the process ends in S850, having addressed all available deals with all the lenders.

If the asset has been depleted in S840, the system checks for further available assets for the pool in S836. If further assets are available in S836, the next asset for this pool is selected, and the process repeats. If no further assets are available in S836, the system checks for additional pools in S832. If additional pools are available in S832, the next pool is selected in S802, and the process repeats. If no further pools are available, the process ends in S834, having tested all available assets from all the available pools.

The approach described with reference to FIG. 8 is best suited to a run where the goal is best value, as for each specific asset, the lenders can be ordered according to how they value the asset. Therefore, to achieve best value, the asset could be allocated first to the lender that values it the highest, and then to other lenders, moving in descending order of value given to the asset.

FIG. 9 is a flow chart illustrating a process of allocation by lender in accordance with an embodiment of the invention. The process begins in S900 and the system selects the next lender in S902. The ordering of the lenders will be influenced by any selections that the borrower has made to highlight some lenders who are to be allocated at a priority, and the goal of the allocation run, e.g. whether best coverage, best value, etc.

After selecting the lender in S902, the system identifies the next deal of this lender in S906. In S910, the system selects the next pool to be used for sourcing assets. As described above, the ordering of the pools is driven by the borrower's selections.

Having selected the pool, the system identifies the next asset from the pool in S912. Within each pool, assets are ordered based on the borrower BQRs. In S916, the system tests the selected asset against the borrower ineligibility schedule. If the asset is considered ineligible in S920, the system determines in S952 whether there are further assets available in the same pool. If further assets are available, the system selects the next asset in S912 and the process repeats. If there are no more assets available in this pool, the system determines in S956 whether there are further pools available. If further pools are available in S956, the system selects the next pool in S910 and the process repeats. Otherwise, the process ends in S962.

If the asset is considered eligible in S920, the system tests in S922 whether the asset breaks any settings related to corporate actions dates or board lot sizes. If the asset breaks either of these settings it is to be considered ineligible in S924. If the asset is ineligible, the process of locating additional assets and/or pools as set forth above is repeated.

If the asset is considered eligible in S924, the system tests against product level eligibility rules in S926. If the asset fails to meet these product level eligibility criteria in S930, it is considered ineligible. If the asset is ineligible, the process of locating additional assets and/or pools as set forth above is repeated.

If the asset is considered eligible in S930, the next step will be to conduct eligibility testing against lender selected eligibility criteria in S932. If the asset fails to meet the lender specified eligibility criteria in S934, it is considered ineligible. If the asset is ineligible the process of locating additional assets and/or pools as set forth above is repeated. If the asset is considered eligible in S934, appropriate discount variables may be applied in S936.

In S942, the system identifies the amount of the asset that will be allocated. In embodiments of the invention, this amount may be calculated as the minimum of: (1) the available amount of the asset, (2) the strictest concentration limit applicable to the asset, and (3) the RQV shortfall. In S946, based on the logic above, the appropriate amount of the asset is allocated. After the allocation, the system updates the records to reflect reduction in the record of the available amount of the asset, reduction in the record of the RQV shortfall, and the amount of concentration limit utilised.

Following the updates, the system determines if the deal has been allocated. If the deal has not been allocated in S950. If the deal has not been allocated, the system checks to see if further assets and pools are available as set forth above and if further assets and/or pools are available, the process repeats.

If the deal has been allocated in S950, a check is made to see if further deals are available for this lender in S964. If further deals are available in S964, the next deal for this lender is selected in S906, and the process repeats. If no further deals are available for this lender in S964, the system checks for further lenders in S966. If further lenders are available in S966, the next lender is selected, and the process repeats. If no further lenders are available, the process ends in S960, having addressed all available deals from all the available lenders.

The approach of FIG. 9 is be best suited to a run where the goal is best coverage, because if a particular lender is not being successfully allocated, the process can be rolled back, the sequence of lenders modified, and a fresh attempt made at allocation. The successful sequence could then be utilised as the starting sequence for the following allocation run, increasing the probability of achieving a successful run while carrying out fewer iterations.

FIG. 10 is a screen shot 1000 illustrating a display of participant positions in accordance with an embodiment of the invention. This display may be provided through the above-described front end interactive components. Participants have a view of all of their global obligations, irrespective of type and region of obligation. Furthermore, these obligations may be real obligations or hypothetical. These positions are displayed when a borrower accesses the long box through the collateral management system. In embodiments of the invention, the display may also provide information with respect to notional, external, and shared long boxes, as well as escrow accounts. Information 1010 may be displayed for the borrower and may include asset class, description, and total amount. The information may further break down assets into received, rehypothecatable, unavailable, encumbered, pending receipts, ad total pending. The information may additionally include a chart. Functions 1020 may allow a user to filter, search, print, export, and refresh the display. A menu 1030 may provide additional functions including a dashboard with alerts, reports, search capability, entitlements, and preferences. Search functions 1040 may also be provided.

FIG. 11 is a screen shot 1100 illustrating an additional display of participant positions in accordance with an embodiment of a dashboard function of the invention. Alerts 1110 may be categorized by type and include description, product, status, date, and/or other information. The screenshot 1100 may also include snapshots 1120 providing a graphic view of accounts and quantifying and characterizing assets. Additional functionality 1130 includes reports, searching, and entitlements. Search functions 1140 are also provided.

The components shown in the FIGs. referenced above may be, include, or be implemented by a computer or multiple computers. The components may be described in the general context of computer-executable instructions, such as program modules, being executed by a computer. Generally, program modules include routines, programs, objects, components, data structures, etc. that perform particular tasks or implement particular abstract data types.

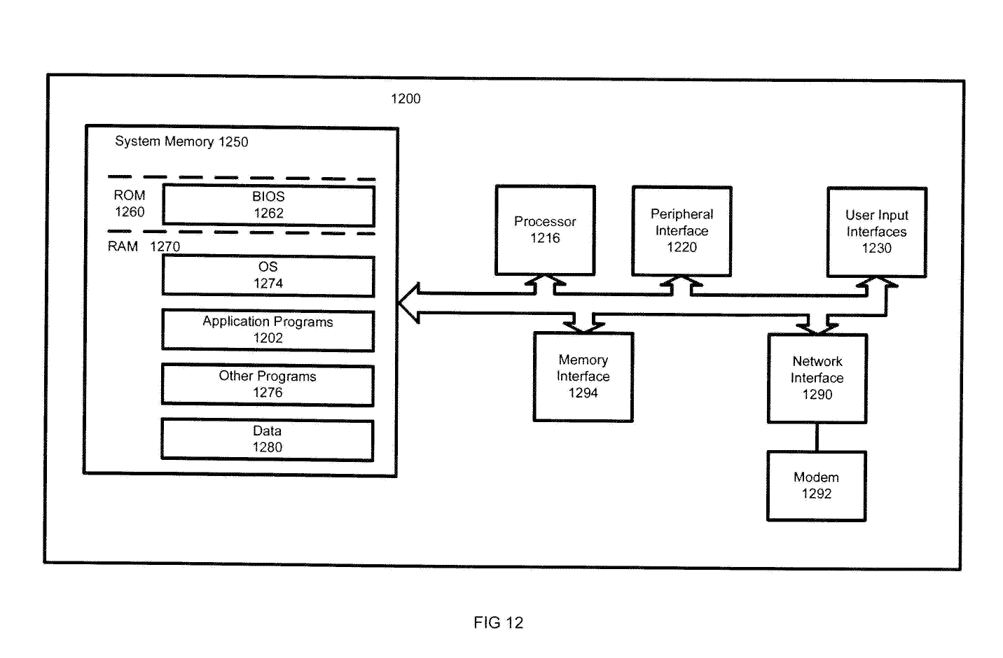

FIG. 12 is a block diagram illustrating a computing system 1200 implementing the collateral management application programs 1202 in accordance with an embodiment of the invention. This configuration is merely exemplary and should not be construed as limiting. The computing system 1200 may include a processing unit 1216, a peripheral interface 1220, a user input interface 1230, a system bus, a system memory 1250, a network interface 1290, a communication device 1292, and a memory interface 1294. The system bus 1240 may be provided for coupling the various system components.

Computers typically include a variety of computer readable media that can form part of the system memory and be read by the processing unit. By way of example, and not limitation, computer readable media may comprise computer storage media and communication media. The system memory 1250 may include computer storage media in the form of volatile and/or nonvolatile memory such as read only memory (ROM) 1260 and random access memory (RAM) 1270.

A basic input/output system (BIOS) 1262, containing the basic routines that help to transfer information between elements, such as during start-up, is typically stored in ROM 1260. RAM 1270 typically contains data and/or program modules that are immediately accessible to and/or presently being operated on by processing unit. The data or program modules may include an operating system 1274, application programs 1202, which might include various eligibility and allocation programs, other program modules 1276, and program data 1280. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system of platform.

At a minimum, the memory 1250 includes at least one set of instructions that is either permanently or temporarily stored. The processor 1216 executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The application programs related to collateral management may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit 1216 that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through a user interface 1230 that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface 1220. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention. These networks may include any of those described above with reference to FIG. 1. Although many other internal components of the computer are not shown, those of ordinary skill in the art will appreciate that such components and the interconnections are well known. Accordingly, additional details concerning the internal construction of the computer need not be disclosed in connection with the present invention.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Although the aforementioned components are shown as discrete modules, each of the modules may alternatively be integrated with one another. If the modules are discrete, multiple modules may operate cooperatively as will be further explained below.

Although many other internal components of the computer are not shown, those of ordinary skill in the art will appreciate that such components and the interconnections are well known. Accordingly, additional details concerning the internal construction of the computer need not be disclosed in connection with the present invention.

Thus, embodiments of the present invention are directed a system and method for offering global collateral management financing and liquidity services and in particular to implementing an improved eligibility and allocation platform for global collateral management. The proposed system will implement a single comprehensive platform for managing collateral positions, eligibility, and allocation across multiple obligation types and multiple regions.

Participants will have a global view of their positions and obligations in the global long box. The global long box will have the capability to include internally held real and hypothetical positions as well as those that have been rehypothecated. Furthermore, externally held positions that are in the participant's own account, for example in Euroclear or DTCC, will be included. The long box serves as a custody or holding account into which assets are delivered for eventual allocation, whether this be for real or hypothetical.

The eligibility and allocation system allocates collateral from the global long box in a borrower selected manner across all the global obligations, whilst considering eligibility criteria set by both lenders and borrowers on those obligations. The eligibility and allocation engine accesses a data repository that functions as a centralized source of eligibility and position data for all collateral management products. The system has the capability for both actual and hypothetical allocation. The allocation system uses a set of algorithms and rules to ensure positions are collateralized according to configurable set of allocation rules and eligibility criteria.

Although the platform will be available globally, it may be distributed locally within an organization and to organizational participants. Furthermore, the platform enables global management of all different types of collateral. In order to operate globally, the platform must support many types of currencies and operate across time zones.

In terms of performance, the proposed system will have superior high-speed application performance, flexibility and scalability, and will perform many functions in real-time. In summary, the proposed global platform includes global capabilities, and simplifies participant use by providing an improved user interface, advanced reporting capabilities, minimal manual processes with as much automated workflow for participant on-boarding, deal processing, margin management, alongside central and secure storage for eligibility requirements and a single eligibility and allocation algorithm. There will be interfaces between the system and other internal and third-party utilities.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations.

1. A computer-implemented collateral management system for managing collateral of multiple participants including borrowers and lenders, the system comprising:
a global long box available to each borrower, each global long box configured for storing all types of available assets possessed by each borrower;
an eligibility database storing eligibility and concentration limits, the concentration limits defined by lender rules controlling the acceptability of the available assets for use as collateral, the value of the assets, and overall acceptable composition of assets;
an interactive participant interface accepting collateral use preferences from the borrowers, the collateral use preferences including, lender ranking components, asset ranking components, and allocation run type selection components for facilitating collateral allocation; and
an allocation engine implementing computer processing components for selecting an allocation sequence based on the collateral use preferences of the borrowers and in compliance the stored eligibility and concentration limits in the eligibility database and allocating collateral from each global long box in the selected sequence.

2. The system of claim 1, the eligibility and concentration limits including parameters established for the requirement of acceptable collateral by lenders including eligible types of collateral and an amount of collateral.

3. The system of claim 1, wherein the global long box permits aggregation of cash and securities collateral balances for each participant across multiple countries and collateral management products.

4. The system of claim 1, further comprising eligibility selection components available through the interactive participant interface for allowing lender selection of eligible collateral.

5. The system of claim 1, further comprising eligibility selection components allowing the borrowers to designate ineligible assets.

6. The system of claim 1, wherein the collateral use preferences include borrower ranking of assets based on asset pool, the asset pools including available collateral from the global long box, unavailable collateral, collateral reserved for market trades, collateral reserved for internal transfers, assets from external long boxes, cash assets, credit.

7. The system of claim 1, wherein the interactive participant interface provides lender selection options to allow borrowers to select an order of lenders for allocation.

8. The system of claim 1, wherein the interactive participant interface includes run type selection components for allowing selection between types of allocation runs.

9. The system of claim 8, wherein the run type selection components include a top-up allocation option for specifying collateralization of specific accounts and allowing collateralized accounts to remain collateralized.

10. The system of claim 8, wherein the run type selection components include an optimization allocation run option for allowing borrowers to select one of a best coverage allocation run and a best value allocation run.

11. The system of claim 10, wherein the optimization allocation run option further provide borrowers with lender selection options.

12. The system of claim 8, wherein the run type selection components include a minimum movements allocation option to achieve collateralization while requiring a minimum number of movements.

13. The system of claim 8, wherein the run type selection components include a simulation allocation run option for allowing participants to initiate a hypothetical allocation run.

14. The system of claim 8, wherein the run type selection components include a rehypothecation option for allowing participants to elect to rehypothecate assets.

15. A computer-implemented collateral management method for managing collateral of multiple participants including borrowers and lenders, the method comprising:
maintaining a global long box available to each borrower, each global long box configured for storing all available types of assets possessed by each borrower;
storing eligibility and concentration limits in an eligibility database, the concentration limits defined by lender rules controlling the acceptability of the available assets for use as collateral, the value of the assets, and overall acceptable composition of assets;
accepting collateral use preferences through an interactive participant interface from borrowers, the collateral use preferences including, lender ranking components, asset ranking components, and allocation run type selection components for facilitating collateral allocation; and
selecting, using an allocation engine implementing computer processing components, an allocation sequence based on the collateral use preferences of the borrowers and in compliance the stored eligibility and concentration limits in the eligibility database; and
allocating collateral using the allocation engine implementing computer processing components in accordance with the selected sequence.

16. The method of claim 15, the eligibility and concentration limits including parameters established for the requirement of acceptable collateral by lenders including eligible types of collateral and an amount of collateral.

17. The method of claim 15, further comprising permitting, in the global long box, aggregation of cash and securities collateral balances for each participant across multiple countries and collateral management products.

18. The method of claim 15, further comprising providing eligibility selection components available through the interactive participant interface for allowing lender selection of eligible collateral.

19. The method of claim 15, further comprising providing eligibility selection components allowing the borrowers to designate ineligible assets.

20. The method of claim 15, wherein the collateral use preferences include borrower ranking of assets based on asset pool, the asset pools including available collateral from the global long box, unavailable collateral, collateral reserved for market trades, collateral reserved for internal transfers, assets from external long boxes, cash assets, credit.

21. The method of claim 15, further comprising providing, through the interactive participant interface, lender selection options to allow borrowers to select an order of lenders for allocation.

22. The method of claim 15, further comprising providing, through the interactive participant interface, run type selection components for allowing selection between types of allocation runs.

23. The method of claim 22, wherein the run type selection components include a top-up allocation option for specifying collateralization of specific accounts and allowing collateralized accounts to remain collateralized.

24. The method of claim 22, wherein the run type selection components include an optimization allocation run option for allowing borrowers to select one of a best coverage allocation run and a best value allocation run.

25. The method of claim 24, wherein the optimization allocation run option further provide borrowers with lender selection options.

26. The method of claim 22, wherein the run type selection components include a minimum movements allocation option to achieve collateralization while requiring a minimum number of movements.

27. The method of claim 22, wherein the run type selection components include a simulation allocation run option for allowing participants to initiate a hypothetical allocation run.

28. The method of claim 22, wherein the run type selection components include a rehypothecation option for allowing participants to elect to rehypothecate assets.

29. A computer-implemented collateral management method for managing collateral of multiple participants including borrowers and lenders, the method comprising:
maintaining a global long box available to each borrower, each global long box configured for storing all available types of assets possessed by each borrower;
storing eligibility and concentration limits in an eligibility database, the concentration limits defined by lender rules controlling the acceptability of the available assets for use as collateral, the value of the assets, and overall acceptable composition of assets, the eligibility and concentration limits including parameters established for the requirement of acceptable collateral by lenders including eligible types of collateral and an amount of collateral expressed as one of an amount and a percentage.
accepting collateral use preferences through an interactive participant interface from the borrowers, the collateral use preferences including, lender ranking components, asset ranking components, and allocation run type selection components for facilitating collateral allocation;
selecting, using an allocation engine implementing computer processing components, a collateral allocation sequence selected based on the collateral use preferences of the borrowers and in compliance the stored eligibility and concentration limits in the eligibility database, wherein the allocation sequence includes at least one of:
an optimization allocation sequence including one of allocating to achieve best coverage of assets and allocating to achieve best value for assets;
a top up allocation sequence including the steps of keeping existing positions locked and allocating only unallocated assets from the borrower global long box; and
a minimum movements allocation sequence including the step of calculating an optimal allocation based on a minimum amount of asset movement; and
allocating collateral using an allocation engine implementing computer processing components for allocating collateral from each global long box in the selected sequence.

30. The method of claim 29, further comprising performing allocation runs using the allocation engine implemented by the computer processor, for redistribution of collateral implementing stored rules allowing an unlimited number of re-use instances of each collateral asset.
